(19) United States
(12) Patent Application Publication
(10) Pub. No.: US 2025/0165652 A1
(43) Pub. Date: May 22, 2025

(54) Application permission establishment method and application permission establishment system

(71) Applicants: Inventec (Pudong) Technology Corp, Shanghai (CN); Inventec Corporation, Taipei (TW)

(72) Inventors: Wei-Chao Chen, Taipei (TW); Ming-Chi Chang, Taipei (TW); Chuo-Jui Wu, Taipei (TW)

(73) Assignees: Inventec (Pudong) Technology Corp, Shanghai (CN); Inventec Corporation, Taipei (TW)

(21) Appl. No.: 18/430,598

(22) Filed: Feb. 1, 2024

(30) Foreign Application Priority Data
Nov. 16, 2023 (CN) 202311533424.X

(51) Int. Cl. G06F 21/62

(52) U.S. Cl. CPC G06F 21/629

(57) ABSTRACT

A method of establishing application permissions includes utilizing a computing device to execute the following steps: requesting a first permission; determining whether the first permission exists in a plurality of application permissions in a permission table; obtaining the first permission when the first permission exists in the plurality of application permissions in the permission table; and reviewing the first permission when the first permission does not exist in the plurality of application permissions in the permission table.

### BACKGROUND OF THE INVENTION

### 1. Field of the Invention

The present invention relates to an application permission establishment method and an application permission establishment system, and more particularly, to an automated and systematic application permission establishment method and application permission establishment system.

### 2. Description of the Prior Art

As the demand for informatization and confidentiality grows, enterprises usually store highly confidential information, such as order information, financial information and procurement information, in the internal data center. The access to the confidential information may vary among employees from different organizations or levels within the company. Therefore, to address information security concerns, it is crucial for the data center to establish a permission mechanism that regulates the data permissions for different employees.

However, at present, the data permissions in the data centers are primarily granted through manual review. In general, an audit committee first collects data access requirements from each employee and then decides appropriate data permissions for each employee. Such a complicated permission establishment method not only increases time expenditure, but also poses potential data security risks to the company.

Under such circumstances, how to automate and systematize the application permission establishment method and the application permission establishment system and accelerate the digital transformation has become one of the goals of the industry.

### SUMMARY OF THE INVENTION

Therefore, the purpose of the present invention is to provide an application permission establishment method and an application permission establishment system to improve the drawbacks of the prior art.

The embodiment of the present invention discloses a method of establishing application permissions. The method of establishing application permissions comprising utilizing a computing device to execute the following steps: requesting a first permission; determining whether the first permission exists in a plurality of application permissions in a permission table; obtaining the first permission when the first permission exists in the plurality of application permissions in the permission table; and reviewing the first permission when the first permission does not exist in the plurality of application permissions in the permission table.

The embodiment of the present invention discloses a system of establishing application permissions. The system of establishing application permissions includes a user interface, configured to request a first permission; a storage module, configured to store a permission table; and a data processing module, coupled to the user interface and the storage module, configured to execute the following steps: determining whether the first permission exists in a plurality of application permissions in a permission table; obtaining the first permission when the first permission exists in the plurality of application permissions in the permission table; and reviewing, by the user interface, the first permission when the first permission does not exist in the plurality of application permissions in the permission table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an application permission establishment system according to an embodiment of the present invention.

FIG. 2, FIG. 3 and FIG. 4 are flowcharts of the application permission establishment method according to different embodiments of the present invention.

FIG. 5 is a schematic diagram of the application permission establishment system processing a requisition system permission according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

In embodiments of the present invention, the computing device may adopt at least one of the following examples: a central processor unit (CPU), a graphic processing unit (GPU), a microcontroller (MCU), an application processor (AP), a field programmable gate array (FPGA), an application specific integrated circuit (ASIC), a digital signal processor (DSP), a system-on-a-chip (SOC), and a deep learning accelerator, but are not limited thereto.

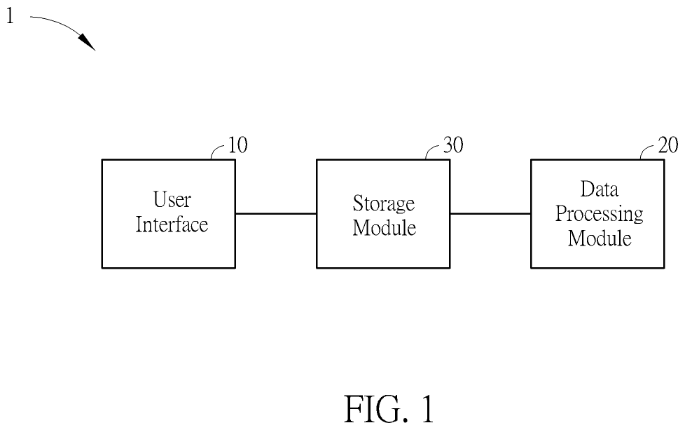

Please refer to FIG. 1. FIG. 1 is a schematic diagram of an application permission establishment system 1 according to an embodiment of the present invention. The application permission establishment system 1 may be configured in a data center to collect user's requirements or requests for data permissions, and automatically and systematically allow a user to obtain the data permissions. The application permission establishment system 1 includes a user interface 10, a storage module 20 and a data processing module 30. The user requests a plurality of data permissions through the user interface 10. The user interface 10 may be an application programing interface (API). The user's request may be converted into a data format of the data center through the API. The conversion of the API is well known in the art, so it is not repeated here. It should be noted that, for the sake of clarity, in the following embodiments, the user requests a first permission as an example, but is not limited thereto. The storage module 20 is configured to store a permission table. The permission table records a plurality of application permissions, which are the application permissions that the user has obtained or may obtain by default. The data processing module 30 is coupled to the user interface 10 and the storage module 20 and configured to execute an application permission establishment method to determine whether the user may obtain the first permission according to the plurality of application permissions in the permission table.

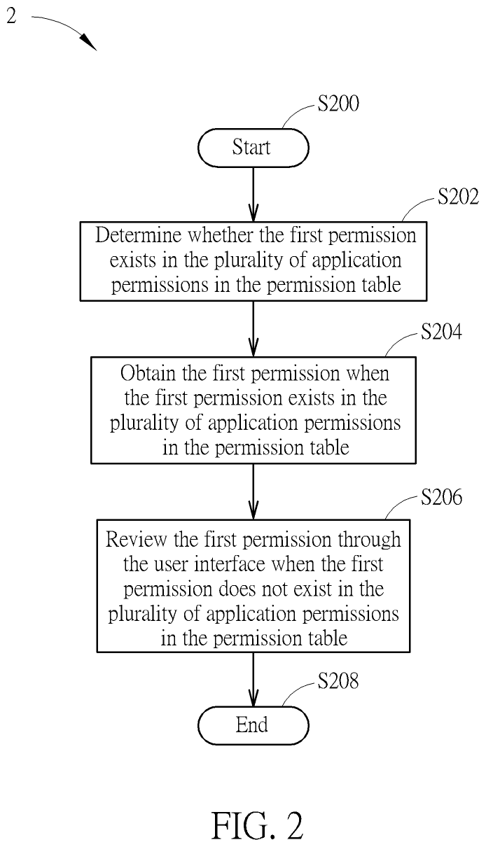

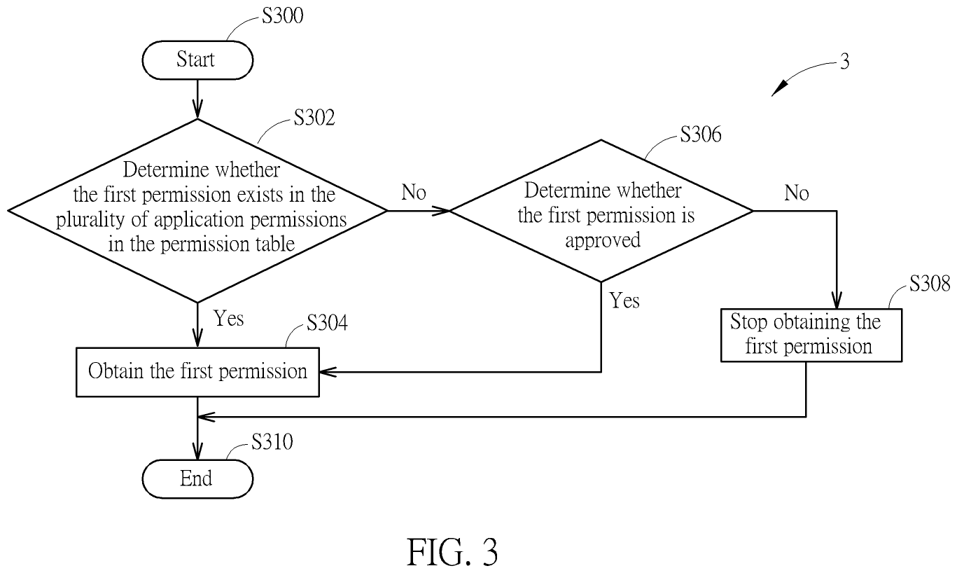

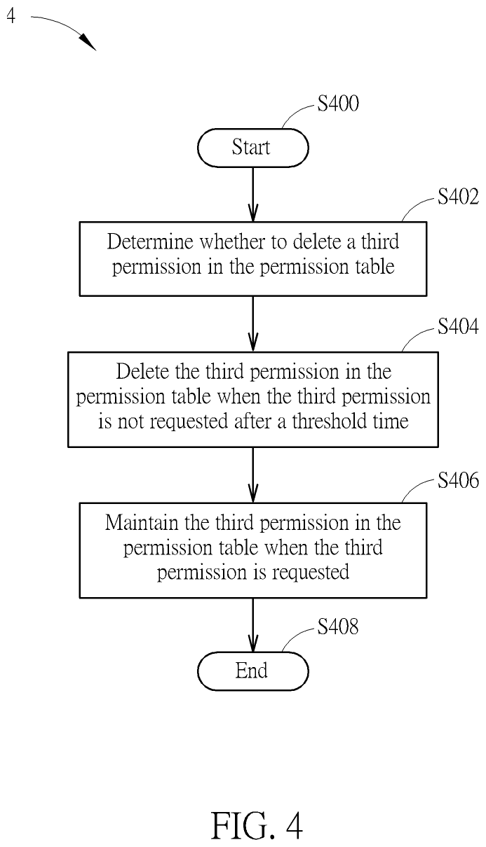

The application permission establishment method of the application permission establishment system 1 may be summarized as a process 2, as shown in FIG. 2. The process 2 includes the following steps:

Step S200: Start.

Step S202: Determine whether the first permission exists in the plurality of application permissions in the permission table.

Step S204: Obtain the first permission when the first permission exists in the plurality of application permissions in the permission table.

Step S206: Review the first permission through the user interface when the first permission does not exist in the plurality of application permissions in the permission table.

Step S208: End.

According to the process 2, in the step S202, when the user requests the plurality of data permissions through the user interface 10, the data processing module 30 determines whether the first permission exists in the plurality of application permissions in the permission table. In the step S204, when the first permission exists in the plurality of application permissions in the permission table, the first permission is an application permission that the user may obtain or has obtained, so the data processing module 30 allows the user to obtain the first permission. Conversely, in the step S206, when the first permission does not exist in the plurality of application permissions in the permission table, the data processing module 30 does not allow the user to automatically obtain the first permission. Therefore, other mechanisms are needed to review whether the user can obtain the first permission. For example, when the first permission does not exist in the plurality of application permissions in the permission table, the data processing module 30 sends the first permission to a review committee, which may be composed of the user's supervisor, etc. Members of the review committee may review the first permission through the user interface 10.

In an embodiment, reviewing the first permission through the user interface may be summarized as a process 3, as shown in FIG. 3. The process 3 includes the following steps:

Step S300: Start.

Step S302: Determine whether the first permission exists in the plurality of application permissions in the permission table. If yes, go to the step S304; if not, go to the step S306.

Step S304: Obtain the first permission.

Step S306: Determine whether the first permission is approved. If yes, go to the step S304; if not, go to the step S308.

Step S308: Stop obtaining the first permission.

Step S310: End.

The detail description and derivative changes of the steps S302, S304 are described as above, and will not repeated here. In the step S306, after receiving the request from the user for the first permission, the members of the review committee review the first permission through the user interface 10. When the first permission fails to be approved, the data processing module 30 may not allow the user to obtain the first permission. Conversely, when the first permission is approved, the data processing module 30 allows the user to obtain the first permission. It should be noted that, the first permission does not exist in the plurality of application permissions in the permission table, so the data processing module 30 may add the first permission into the permission table. In this way, when the user requests the first permission again in the future, the application permission establishment system 1 may automatically approve the request for the first permission without sending to the review committee. In an embodiment, when the application permission establishment system 1 is initially established, there may not be any data permissions in the permission table, so each data permission of the plurality of data permissions requested from the user will go through the step S306. Some data permission of the plurality of data permissions will be added into the permission table after being approved by the review committee.

On the other hand, the review committee may use the application permission establishment system 1 to proactively change (add, update and reduce) the permission table and the user's permission scope. For example, the members of the review committee review a second permission of the plurality of application permissions in the permission table through the user interface 10: when the second permission is approved, maintaining the permission table; when the second permission is not approved, deleting the second permission in the permission table; in addition, if the second permission is the same as the first permission that is requested or has been obtained by the user, stopping obtaining or revoking the first permission.

Furthermore, different users may have different permission scopes and have the permission tables corresponding to different permission scopes, and the data permissions requested by the user may also be different. In order to more effectively manage the permission scope of the user, in another embodiment, the present invention may further add the function of automatically deleting the data permissions, so that there will not be too many data permissions in the permission table and cause information security problems. The function of automatically deleting the data permissions may be summarized as a process 4, as shown in FIG. 4. The process 4 includes the following steps:

Step S400: Start.

Step S402: Determine whether to delete a third permission in the permission table.

Step S404: Delete the third permission in the permission table when the third permission is not requested after a threshold time.

Step S406: Maintain the third permission in the permission table when the third permission is requested.

Step S408: End.

The detail description and derivative changes of the process 4 are described as above, and will not repeated here. It should be noted that the process 4 is a different embodiment of the present invention. Those skilled in the art should readily make modifications, and not limited thereto. For example, when the third permission is not requested after a threshold time, the data processing module 30 deletes the third permission in the permission table, and simultaneously revokes the data permission that has obtained by the user and is the same as the third permission. For example, the data processing module 30 may first determine whether the third permission is the data permissions that the user has obtained. If so, the process 4 will not be executed. If not, the process 4 will start executing.

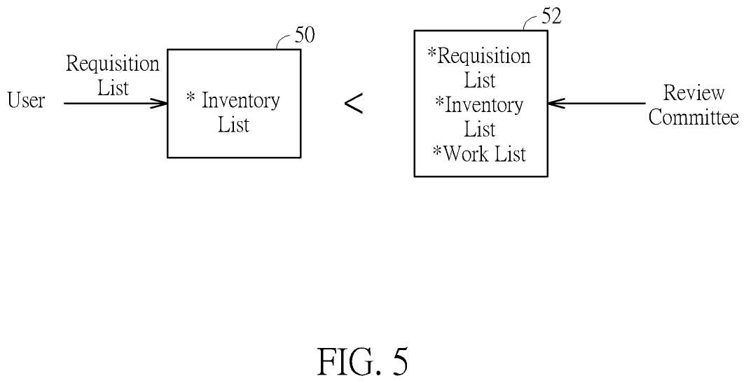

Finally, the operation of the application permission establishment system 1 may be referred to FIG. 5. FIG. 5 is a schematic diagram of the application permission establishment system 1 processing a procurement system permission according to an embodiment of the present invention. The storage module 20 stores a permission table 52 and a user permission table 50. The permission table 52 records the data permissions available to the user, which include a requisition list, an inventory list and a work list. The user permission table 50 records the data permissions that the user currently possesses, which includes the inventory list. In an embodiment, when the user requests the data permissions of the requisition list through the user interface 10, the data processing module 30 determines that the data permissions of the requisition list is included in the data permissions recorded in the permission table 52, so the user may automatically obtain the data permissions of the requisition list. In other words, the data processing module 30 will add the data permissions of the requisition list in the user permission table 50. It should be noted that, as shown in FIG. 5, the user may request a change to the user permission table 50, and the review committee may change the permission table 52. In addition, the data permission scope of the permission table 52 is greater than or equal to the data permission scope of the user permission table 50. In another embodiment, the review committee may delete the data permissions of the inventory list in the permission table 52 (not shown in FIG. 5), and the data processing module 30 determines that the data permissions of the inventory list in the user permission table 50 no longer exist in the permission table 52, so the data processing module 30 correspondingly deletes the data permissions of the inventory list in the user permission table 50.

It should be noted that the application permission establishment system 1 is the embodiment of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (COM) and the application permission establishment system 1. Any of the abovementioned procedures and examples above may be compiled into program codes or instructions that are stored in a storage module 20. The storage module 20 may include read-only memory (ROM), flash memory, random access memory (RAM), subscriber identity module (SIM), hard disk, or CD-ROM/DVD-ROM/BD-ROM, but not limited thereto. The DATA PROCESSING MODULE 30 may read and execute the program codes or the instructions stored in the storage module 20 for realizing the abovementioned functions.

In summary, the application permission establishment method and the application permission establishment system of the present invention may automatically and systematically process the user's request of the data permissions and manage the user's permission scope. The review committee may review and change the user's permission scope through the application permission establishment method and the application permission establishment system of the present invention. In this way, compared with the prior art, the present invention may reduce the labor costs and accelerate the company's digital transformation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of establishing application permissions, comprising utilizing a computing device to execute the following steps:
requesting a first permission;
determining whether the first permission exists in a plurality of application permissions in a permission table;
obtaining the first permission when the first permission exists in the plurality of application permissions in the permission table; and
reviewing the first permission when the first permission does not exist in the plurality of application permissions in the permission table.

2. The method of establishing application permissions of claim 1, further comprising:
obtaining the first permission and adding the first permission into the plurality of application permissions in the permission table when the first permission is approved; and
stopping obtaining the first permission when the first permission is not approved.

3. The method of establishing application permissions of claim 1, further comprising:
reviewing a second permission of the plurality of application permissions in the permission table;
maintaining the permission table when the second permission is approved; and
deleting the second permission in the permission table when the second permission is not approved.

4. The method of establishing application permissions of claim 3, wherein the step of deleting the second permission in the permission table further comprises:
stopping obtaining or revoking the first permission if the second permission is the same as the first permission.

5. The method of establishing application permissions of claim 1, further comprising:
determining whether to delete a third permission in the permission table;
deleting the third permission in the permission table when the third permission is not requested after a threshold time; and
maintaining the third permission in the permission table when the third permission is requested.

6. A system of establishing application permissions, comprising:
a user interface, configured to request a first permission;
a storage module, configured to store a permission table; and
a data processing module, coupled to the user interface and the storage module, configured to execute the following steps:
determining whether the first permission exists in a plurality of application permissions in a permission table;
obtaining the first permission when the first permission exists in the plurality of application permissions in the permission table; and
reviewing, by the user interface, the first permission when the first permission does not exist in the plurality of application permissions in the permission table.

7. The system of establishing application permissions of claim 6, wherein the data processing module further executes the following steps:
obtaining the first permission and adding the first permission into the plurality of application permissions in the permission table when the first permission is approved; and
stopping obtaining the first permission when the first permission is not approved.

8. The system of establishing application permissions of claim 6, wherein the data processing module further executes the following steps:
reviewing, by the user interface, a second permission of the plurality of application permissions in the permission table;
maintaining the permission table when the second permission is approved; and
deleting the second permission in the permission table when the second permission is not approved.

9. The system of establishing application permissions of claim 8, wherein the step of deleting the second permission in the permission table further comprises:
stopping obtaining or revoking the first permission if the second permission is the same as the first permission.

10. The system of establishing application permissions of claim 6, wherein the data processing module further executes the following steps:
determining whether to delete a third permission in the permission table;
deleting the third permission in the permission table when the third permission is not requested after a threshold time; and
maintaining the third permission in the permission table when the third permission is requested.
